(19) United States
(12) Patent Application Publication
(10) Pub. No.: US 2022/0394020 A1
(43) Pub. Date: Dec. 8, 2022

(54) DATA ACCESS CONTROL

(71) Applicant: GENETEC INC., St-Laurent (CA)

(72) Inventors: Pierre RACZ, Montreal (CA); Vincent LABRECQUE, Montreal (CA)

(21) Appl. No.: 17/820,712

(22) Filed: Aug. 18, 2022

Related U.S. Application Data
(63) Continuation of application No. 16/810,438, filed on Mar. 5, 2020.
(60) Provisional application No. 62/927,276, filed on Oct. 29, 2019.

(51) Int. Cl. H04L 9/40; H04L 9/14

(52) U.S. Cl. CPC H04L 63/045; H04L 9/14; H04L 63/061

(57) ABSTRACT

A method for controlling access to data by users, where a system generates a first symmetric encryption key stream and defines a number of shares of which a number is required to calculate each of said symmetric encryption keys; a sequential portions of data being symmetrically encrypted with the symmetric encryption key; the key stream data further being asymmetrically encrypted with at least one public asymmetric encryption key that is received by the system; and transmitting the asymmetrically encrypted key stream data and said first symmetrically encrypted data file or stream comprising sequential portions of encrypted data to a data storage.

This application is a continuation of U.S. patent application Ser. No. 16/810,438 filed Mar. 5, 2020, that in turn claims priority of U.S. provisional patent application Ser. No. 62/927,276 filed on Oct. 29, 2019, the contents of which are hereby incorporated by reference.

### TECHNICAL FIELD

The present application relates to secure access control to data.

### BACKGROUND

Securing access to sensitive data, whether in network storage or on physical media, is important in a variety of applications.

Applicant has proposed in WO2017/083980, published 26 May 2017, data encryption in which random symmetric encryption keys are generated for encrypting blocks of data, while the random symmetric encryption keys are then encrypted using the asymmetric public encryption key of a party authorized to decrypt the random symmetric encryption keys using the corresponding private key, and thus gain access to the encrypted blocks of data. The encrypted data and the encrypted keys can be transmitted together or separately as desired. In most cases, both the encrypted data and the encrypted keys are sufficiently secured to be stored with much lower security levels than for sensitive data storage.

An advantage of the data encryption system disclosed in WO2017/083980 is that security of the sensitive data can be shifted from data access control to possession of keys that allow a user or process to decrypt the data. Data access control is often a centralized process that adds overhead in a secure data storage system.

A disadvantage of the data encryption system disclosed in WO2017/083980 is that security of the sensitive data depends on possession of a single decryption key alone. A user is either granted access or not, and when a user was not originally authorized, the decryption key must be given from a party who had authorization in order to access the data.

### SUMMARY

Applicant has discovered that secret shares can be used to provide users with access to decryption of sensitive data without requiring a centralized data access controller to act as a gatekeeper to grant a user access to sensitive data.

A number of at least two fiduciaries are created who have shares that when combined will permit access to the symmetric encryption keys. As an example, the data source that can create the random symmetric encryption key can, instead of using a public key of an authorized user to asymmetrically encrypt the symmetric key for that user, use a public key of each of a group of ‘m’ authorized users to encrypt a value of a function, for example a polynomial function of degree one or more up to m−1. When the degree is one, the function is a line, and each user receives but one point on the line. An intercept of the line (or any other property) can be the symmetric key.

When a user knows one point on the line, it is not possible to guess the key, however, with a second point shared by another user, it is possible to calculate the key value. The number of fiduciaries can be large if desired. The order or degree of the function determines how many fiduciaries must combine their information to obtain the symmetric key. With the function being known to the user, or encrypted for the user, the receipt of the block data and the key data encrypted for the user only provides a potential for access without actually creating immediate conditions for access. The user must ask one or more other users to share the key data that the other users received in order to compute the symmetric key for the block. Asking for another key share may be done through a network, where communications are encrypted, or it may otherwise be performed physically, by an exchange of keys residing in physical mediums (e.g. usb key).

Alternatively to the use of a polynomial function, the symmetric encryption key can be made the sum or other function of two or more values used as the shares.

A first broad aspect is a method for controlling access to data by users, including, at an encryption computer system obtaining from a key generator a first symmetric encryption key stream including a first plurality of distinct symmetric encryption keys, wherein for each of the symmetric encryption keys, a number of ‘n’ shares are issued of which a number ‘m’ are required to calculate each of the symmetric encryption keys, and the shares represent the first symmetric encryption key stream; encrypting respective sequential portions of a first data file or stream to create a first symmetrically encrypted data file or stream including sequential portions of encrypted data; receiving at least one public asymmetric encryption key; generating asymmetrically encrypted key stream data by digitally encrypting by the encryption computer system the first symmetric encryption key stream using each one of the at least one public asymmetric encryption keys to create respective asymmetrically encrypted first key streams wherein each of the asymmetrically encrypted first key streams is encrypted with a respective one of the at least one public asymmetric encryption keys, the asymmetrically encrypted key stream data including each of the asymmetrically encrypted first key streams; and from the encryption computer system, transmitting the asymmetrically encrypted key stream data and the first symmetrically encrypted data file or stream including sequential portions of encrypted data to a data storage for access by parties associated with the at least one public asymmetric encryption key.

In some embodiments, the shares are values of a polynomial function of an order equal to m−1.

In some embodiments, n is greater than m.

In some embodiments, the shares are values than can be combined by an arithmetic or logical function to calculate the first symmetric encryption key stream.

In some embodiments, the encryption computer system issuing the number of ‘n’ shares further issues, for each of the ‘n’ shares, a number of ‘g’ sub-shares of which a number ‘h’ are required to calculate each of the ‘n’ shares, and the sub-shares represent the shares.

In some embodiments, the sub-shares are values of a polynomial function of an order equal to h−1.

In some embodiments, g is greater than h.

In some embodiments, the sub-shares are values than can be combined by an arithmetic or logical function to calculate the first symmetric encryption key stream.

Another broad aspect is a computer-readable non-transitional memory storing instructions executable by a computer device, including: at least one instruction for causing an encryption computer system to obtain, from a key generator, a first symmetric encryption key stream including a first plurality of distinct symmetric encryption keys, wherein for each of the symmetric encryption keys, a number of ‘n’ shares are issued of which a number ‘m’ are required to calculate each of the symmetric encryption keys, and the shares represent the first symmetric encryption key stream; at least one instruction for encrypting respective sequential portions of a first data file or stream to create a first symmetrically encrypted data file or stream including sequential portions of encrypted data; at least one instruction for receiving at least one public asymmetric encryption key; at least one instruction for generating asymmetrically encrypted key stream data by digitally encrypting by the encryption computer system the first symmetric encryption key stream using each one of the at least one public asymmetric encryption keys to create respective asymmetrically encrypted first key streams wherein each of the asymmetrically encrypted first key streams is encrypted with a respective one of the at least one public asymmetric encryption keys, the asymmetrically encrypted key stream data including each of the asymmetrically encrypted first key streams; and at least one instruction for transmitting the asymmetrically encrypted key stream data and the first symmetrically encrypted data file or stream, from the encryption computer system, including sequential portions of encrypted data to a data storage for access by parties associated with the at least one public asymmetric encryption key.

### BRIEF DESCRIPTION OF THE DRAWINGS

The proposed solutions will be better understood by way of the following detailed description of embodiments of the invention with reference to the appended drawings, in which:

FIG. 1 is an illustration of a prior art data encryption system which encrypts the data payload with a randomized number, the session key, which itself is encrypted with the public key of the trusted recipient;

FIG. 2A is an illustration of an embodiment in which the data encryption system encrypts the data payload with a randomized number, the session key, which itself is separated into fiduciary shares that are encrypted with their respective recipient's public key;

FIG. 2B is an illustration of an embodiment in which the data encryption system encrypts the data payload with a randomized number, the session key, which itself is separated into fiduciary shares that are further separated in fiduciary sub-shares that are encrypted with their respective recipient's public key;

FIG. 3 is a flow diagram setting out steps involved in generating and encrypting the fiduciary shares according to an embodiment in which the session key is separated in fiduciary shares;

FIG. 4 is a flow diagram setting out steps involved in solving the session key once the required fiduciary shares of the session key are received, according to an embodiment in which the solution is obtained using the Lagrange basis polynomial;

FIG. 5A is an illustration of an embodiment in which the fiduciary parameter results in a first order polynomial, which requires two fiduciary shares to solve, and a representation of the session key which is a zero of the polynomial function;

FIG. 5B is an illustration of an embodiment in which the fiduciary parameter results in a second order polynomial, which requires three fiduciary shares to solve, and a representation of the session key which is a zero of the polynomial function;

FIG. 6 is a flow diagram setting out steps involved in viewing encrypted data according to an embodiment in which the requesting user receives the authorization to view the encrypted data in the form of fiduciary shares required to solve and obtain the session key that is used to decrypt the data;

FIG. 7 is a flow diagram setting out steps involved in solving the session key according to an embodiment in which the received fiduciary shares are encrypted;

FIG. 8 illustrates an embodiment of a system able to implement the process of FIG. 6 and FIG. 11;

FIG. 9 illustrates an embodiment of a system able to implement the process of FIG. 10;

FIG. 10 is a flow diagram setting out steps involved in viewing encrypted data according to an embodiment in which the requesting user receives the authorization to view the encrypted data in the form of a single control share that is required to obtain the session key that is used to decrypt the data; and

FIG. 11 is a flow diagram setting out steps involved in viewing encrypted data according to an embodiment in which the requesting user receives the authorization to view the encrypted data in the form of fiduciary sub-shares required to solve and obtain the fiduciary shares to further solve and obtain the session key that is used to decrypt the data;

FIG. 12 illustrates an embodiment of a system able to implement the process of FIG. 10, in which the fiduciary sub-shares are communicated via physical mediums;

FIG. 13 is a flow diagram setting out steps involved in viewing encrypted data according to an embodiment in which the requesting user obtain physical copies of the fiduciary sub-shares required to solve and obtain the fiduciary shares to further solve and obtain the session key used to decrypt the encrypted data payload.

### DETAILED DESCRIPTION

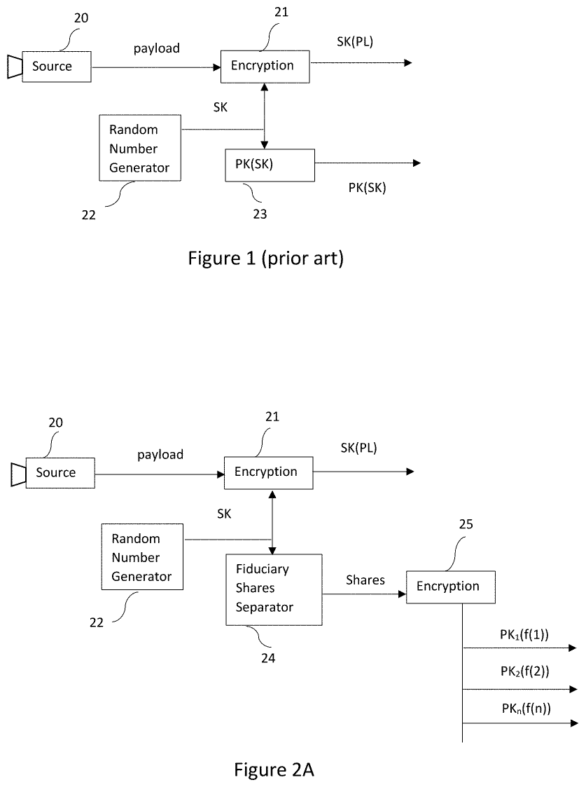

FIG. 1 provides a simplified system diagram implementing an encryption technique described in Applicant's PCT patent application publication WO2017/083980, dated 26 May 2017. The sensitive data 20 is arranged in blocks with the data payload being encrypted 21 by a randomly generated session key 22. The session key is then encrypted using the public key 23 of a party that is authorized to decrypt the session key and thus have access to the encrypted sensitive data.

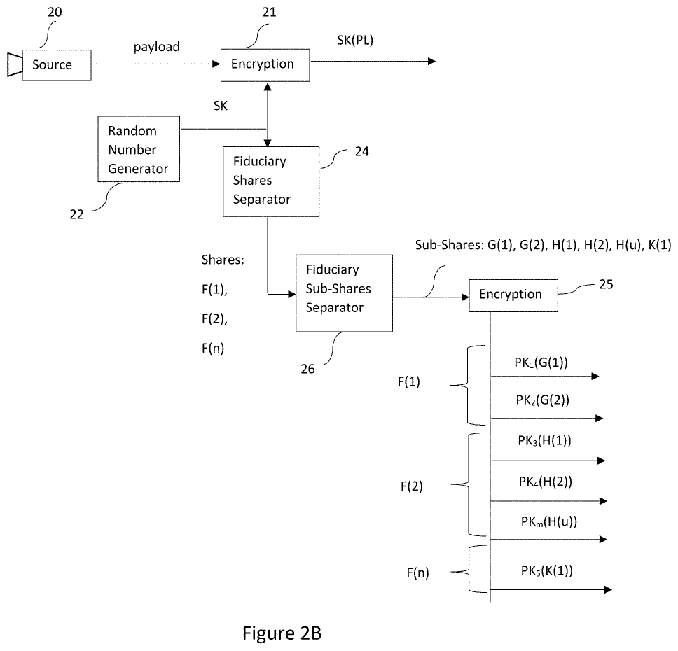

FIG. 2A provides an embodiment of Applicant's solution to solve the problem of the single point of failure in the encrypted data access. In this embodiment, the Session Key (SK), generated randomly 22, used to encrypt the payload data 21 is separated into multiple fiduciary shares 24. The fiduciary shares may then be encrypted 25 using their respective trusted party asymmetrical public key. The separation of the Session Key into shares is an implementation of the Shamir Secret Sharing (SSS) cryptography algorithm.

As is known in the art, the Shamir Secret Sharing algorithm provides a way to divide a given secret, herein the Session Key, into unique parts that are passed down to different participants. In order to reconstruct the secret, a minimum number of participants need to come together and provide their unique part. This technique ensures that even if a share, or multiple shares, has been compromised, it remains impossible to access the encrypted sensitive data if the threshold of required shares is not reached. This threshold of required shares is further defined as the fiduciary parameter.

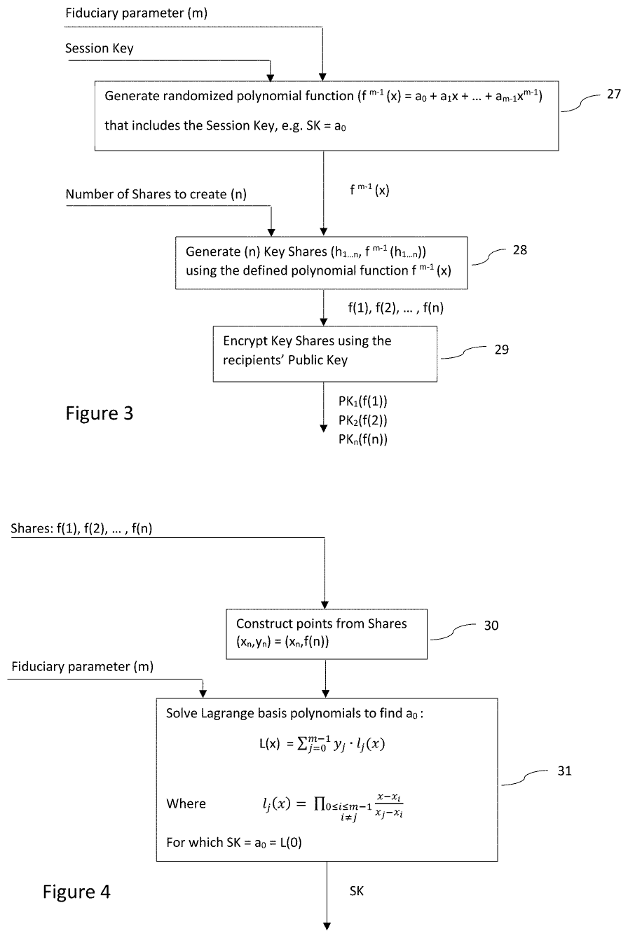

The implementation of SSS is done through the definition of a polynomial of the order that is equivalent to the fiduciary parameter minus one. As will be further illustrated in FIG. 3, the polynomial includes the Session Key as a point and has the other mathematical coefficients randomly generated. The fiduciary shares are then generated such as they represent points on the polynomial function. The number of shares generated is equivalent to the number of trusted parties that may receive a share and thus act as a requesting or authorizing party in an encrypted data access request.

In an embodiment of the present application, the Session Key is randomly generated to be a randomized 512-bit integer value. The space in which the mathematical calculations for the SSS implementation are being computed may also comprise values ranging from 0 to 2⁵¹²⁻¹ both in the horizontal and vertical axes. Computer extensions to perform calculations on 512-bit vectors on processors, such as Intel's AVX-512, may be used. It will be appreciated by someone skilled in the art that the implementation of this solution may be done using different bit lengths, whether to a lesser or greater length, as this only affect the level of security by reducing or increasing the amount of possible encryption key.

FIG. 2B illustrates an embodiment of the present solution for which a nested SSS system is implemented. Similarly to FIG. 2A, the data payload 20 is encrypted 21 using a randomly generated Session Key 22, which is then separated in fiduciary shares 24. The difference lies in the fact that those fiduciary shares are then further separated in fiduciary sub-shares 26. This may be used for situations in which multiple categories of authorizing parties exist, to ensure that no multiple parties of one single category may come together to solve the secret and gain access to the encrypted data. Similarly to the fiduciary shares of FIG. 2A, the fiduciary sub-shares may be encrypted 25 with their respective recipient's public key.

An example of a situation for which the sub-shares may be useful is for the access to encrypted data, such as video surveillance footage, in a police investigation. During an investigation, an investigator may require access to sensitive data that requires authorization from either his supervisor, a judge, both or any number of supervisors and judges. If every participant receives a unique share of the Session Key required to decrypt the requested video surveillance footage, a number of participants from only one of the categories, such as multiple investigators, may come together and be able to solve the Session Key secret without inputs from a supervisor and a judge.

The embodiment of FIG. 2B presents separating the fiduciary shares 24 in multiple fiduciary sub-shares 26, where a certain number of fiduciary sub-shares need to come together to obtain a certain fiduciary share. In the previous example, each category of the investigators, the supervisors and the judges may have one of the required fiduciary share. Therefore, it may be required that any number of judges come together to obtain the category's fiduciary share, same for the category's share of the supervisors and the investigators. It will be appreciated that any combination may be done for any number of fiduciaries in any number of categories.

In yet another embodiment, the nested SSS system implementation may be replaced by using non-unique fiduciary shares, such that a number of parties have the same fiduciary share. In this embodiment, all the categories from the previous example may have a single fiduciary share per category, thus effectively preventing multiple parties from a given category from having access by itself to the Session Key. This embodiment has the disadvantage of not being able to track which specific parties gave their authorization to access the encrypted data, although this may be done through any other means.

The embodiments illustrated in FIGS. 2A and 2B show the fiduciary share and sub-share separations being done prior to the encrypted data storage. In another embodiment, in which the data is encrypted with the Session Key and stored as-is, the calculations of the fiduciary shares may be done further in the system. This may be implemented as an authenticator system which receives the Session Key, calculates fiduciary shares or sub-shares and provides them to the participants encrypted with their own public key.

FIG. 3 illustrates an embodiment of the process required to generate the fiduciary shares to be distributed to the trusted parties. Once the fiduciary parameter, which represents the minimum number of parties that need to come together to authorize access to the encrypted data, is known, the system pseudo-randomizes a polynomial 27 with the following limitations: the polynomial order is equal to the fiduciary parameter minus one, and the polynomial function is required to include the Session Key as one of its points. In this embodiment, the Session Key is the zero of the polynomial function. Once the polynomial function is defined, the system creates a number of points 28, one for each number of desired fiduciary shares. The number of fiduciary shares to be created may be equivalent to the number of trusted parties that will receive a unique fiduciary share, or it may be any lesser number if the implementation is done using the non-unique fiduciary share solution. The created fiduciary shares are then encrypted 29 with the public key of the receiving trusted parties.

In another embodiment, the process illustrated in FIG. 3 similarly represents the process of creating fiduciary sub-shares. The system may have a fiduciary sub-share parameter and the fiduciary share or shares that requires to be further divided in sub-shares as inputs. The system generates a new pseudo-randomized polynomial function with the following limitations: the polynomial order is equal to the fiduciary sub-share parameter minus one, and the polynomial function is required to include the fiduciary share or shares as one, or more, of its points. The remaining process is the same as the one presented in FIG. 3.

FIG. 4 illustrates an embodiment of a key solver which may take the fiduciary shares and reconstruct the secret 46, which may be the Session Key. The solver system receives the fiduciary shares and construct data points 30 for each of the shares, such that each share is represented by its horizontal and vertical axes values; the vertical axis value representing the polynomial function solved for the given horizontal axis value. In this embodiment, the solver further receives the fiduciary parameter that was used to produce the fiduciary shares for the block of data being requested, such that it may deduce the order of the polynomial it solves. Having a sufficient amount of points to define the polynomial at its given order, the system may then perform calculations to retrieve the initial polynomial equation, which yields the answer to the Session Key secret.

In another embodiment, the process illustrated in FIG. 4 is used similarly to solve the fiduciary shares secret from a given set of fiduciary sub-shares. In this case, the solver may use this process any number of time in order to produce the minimum number of fiduciary shares required for the process to be ran on those fiduciary shares to ultimately find the Session Key.

In the embodiment shown in FIG. 4, the solver performs the reconstruction of the polynomial by using the Lagrange basis polynomials formula 31. This method is a polynomial interpolation method usually associated with Shamir's Secret Sharing cryptography applications, and has the advantage of requiring a low amount of computation when the secret is a zero of the polynomial function, since the mathematical equations may be simplified.

It will be appreciated by someone skilled in the art that, in other embodiments, the reconstruction of the polynomial may be made using any other polynomial interpolation methods, such as Newton polynomials.

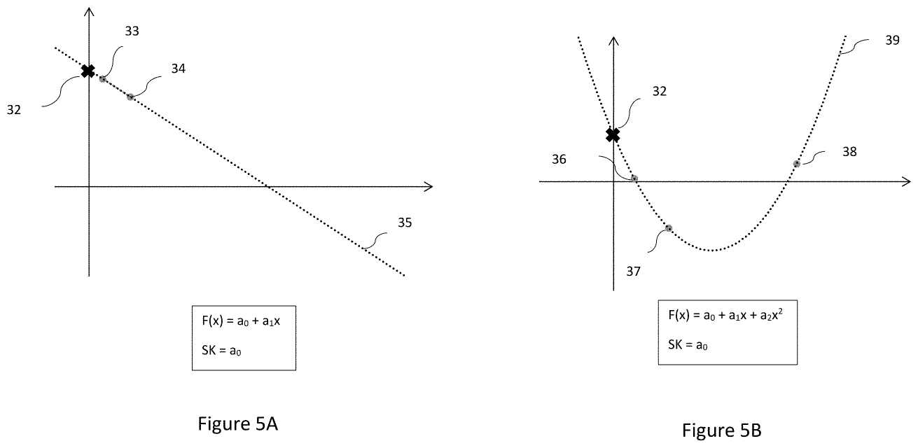

FIG. 5A illustrates an embodiment for which the fiduciary parameter results in a first order polynomial 35. This polynomial is thus defined by two points 33 34, two fiduciary shares, and the Session Key 32 is equal to a zero of this first order polynomial function. Should more fiduciary shares be required, for example one for each trusted parties, the additional shares would consist of points lying on the polynomial function.

FIG. 5B illustrates another similar embodiment, one for which the fiduciary parameter results in a second order polynomial 39. This polynomial is thus defined by three points 36 37 38, three fiduciary shares, and the Session Key 32 is equal to a zero of this second order polynomial function. Should more fiduciary shares be required, for example one for each trusted parties, the additional shares would consist of points lying on the curve of this polynomial function.

In another embodiment, the polynomial function may be of any higher polynomial order, as would be defined by the fiduciary parameter input. In some embodiments, the secret may be any point along the polynomial function. The point may be defined as the function result at a randomized location or at a location that may be defined by an administrator of the security system.

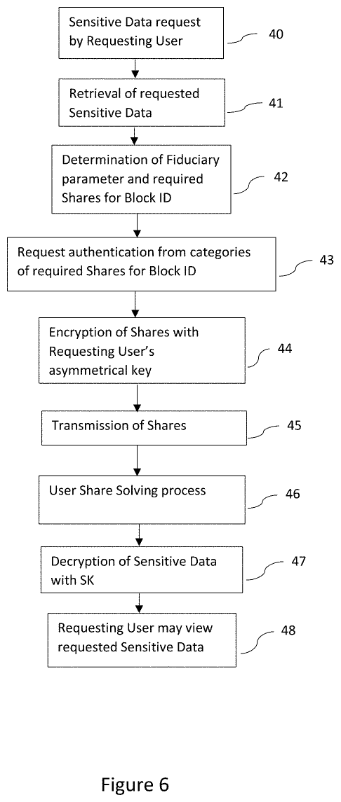

FIG. 6 is an illustration of an embodiment of the process to allow a requesting user to view the sensitive data that is requested. Once a user requests access to encrypted data 40, the specific data block being requested is retrieved 41 in order to determine the fiduciary parameter 42 that was used for the data encryption along with the categories from which the system requires authorization from 43, for implementations of the system which feature different categories. It will be appreciated that the information on the fiduciary parameter and the different levels of authorization required from different parties of different categories may be stored in the data block itself or within a separate database.

In this embodiment of the data access process, the requested fiduciary shares may be transmitted to the requesting user 45 after being encrypted with the public key of the requesting user 44. Thereafter, the requesting user may proceed with the share solver 46 in order to determine the Session Key with which the requested sensitive data has been encrypted. The Session Key determined, the requesting user may then decrypt 47 and view the sensitive data 48.

In some embodiments, the sensitive data 48 may be a single data file whereas, in other embodiments, the sensitive data 48 may be a data stream. Streams of data, such as security camera video footage, may be separated in multiple data files each containing a given amount of data (e.g. separated when reaching a certain time length or when reaching a certain file size). The separation and encryption of multiple data files of a data stream may significantly increase the security of data access, since gaining access to a single data file does not grant access to the whole data stream (i.e. an unauthorized user finding the decryption key for a data file may only view a 5 second video clip of a security camera video footage instead of a full day of video surveillance).

In order to view a requested data stream, the requesting user may receive the plurality of fiduciary shares required to find all the Session Keys necessary to decrypt the sequential portion of the data stream that was requested. This may be implemented in order for the requesting user to be able to watch continuous footage without the system having to process new queries each time a data file from the requested data stream is finished playing.

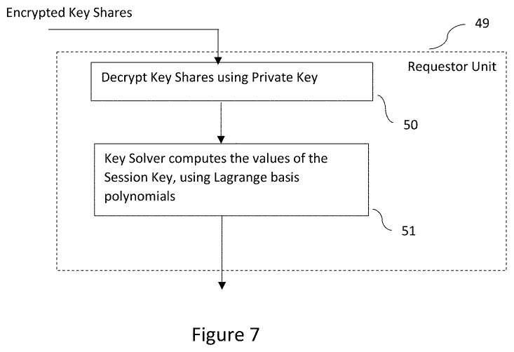

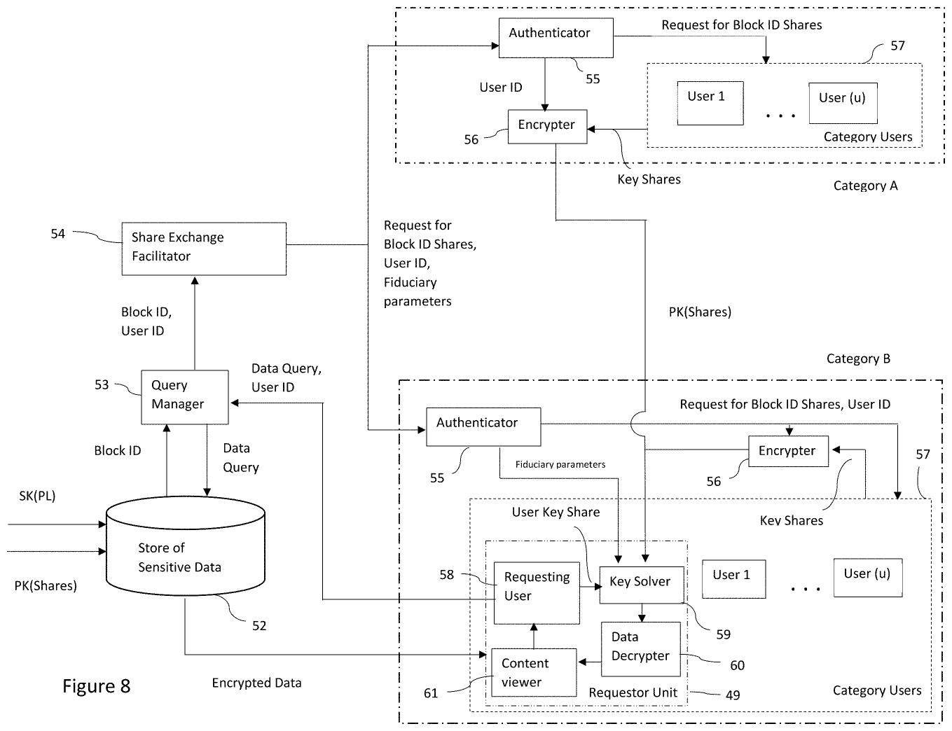

FIG. 7 illustrates an embodiment of the requestor's unit 49 performing the solving process as shown in FIG. 4. In this embodiment, the fiduciary shares are received encrypted with the requesting user's public key. The first step of the process is thus to decrypt those fiduciary shares using the requestor's private key 50. The key solving process 51 may then be performed on those decrypted fiduciary shares. Per design, the decryption and solving may be done inside the requestor's computer unit, in order to reduce the possibilities for an unwanted party to gain access to the fiduciary shares. In another embodiment, the decryption may be performed on fiduciary sub-shares, which would then go through a first solving process to determine the fiduciary shares and would further go through a second solving process to result in the desired Session Key.

FIG. 8 illustrates an embodiment of a system capable of implementing the processes described in previous Figures. The sensitive data, each data blocks being defined by a Block ID, is stored in a database 52 in an encrypted format, with a specific Session Key for the data payload and the Session Key being further separated in encrypted fiduciary shares. It will be appreciated that the Store of Sensitive Data 52 may be accessible to all users of all categories 57, as the data content residing inside may already be encrypted to prevent unauthorized access. A user requesting access 58 to sensitive data sends a query to a Query Manager module 53. The Query Manager module 53 retrieves the requested Block ID from the Store of Sensitive Data 52 and communicates the Block ID and the requesting user's User ID to a Share Exchange Facilitator module 54.

The Share Exchange Facilitator module 54 accesses the information on how the data from the Block ID was encrypted, namely the fiduciary parameter that was defined based on the desired number of trusted parties that are required to come together in order to unlock the secret of the Session Key. In an embodiment in which multiple categories of trusted parties exists, as shown in FIG. 8, the Share Exchange Facilitator 54 may also access the data consisting of the fiduciary sub-share parameters and thus the number of required trusted parties from the different categories. The Share Exchange Facilitator 54 then provides the request for a number of shares, the Block ID, the User ID and the fiduciary parameters to an Authenticator 55 for each of the categories.

It will be appreciated that the Share Exchange Facilitator 54 is only one of the possible ways for a requesting user 58 to obtain the required fiduciary shares to unlock the Session Key and access the sensitive data. The Share Exchange Facilitator 54 provides an automated service that may very well be replaced by any other means, such as the requesting user personally asking trusted parties 57 from other categories to provide him with their fiduciary share. The trusted parties 57 may then provide their fiduciary share to the requesting user 58 through the Encrypter 56, such that their fiduciary shares are not being transmitted unencrypted. In such embodiment, the users would have access to a repository of data concerning the fiduciary parameters for each Block ID of encrypted data. Furthermore, the users may have access to a list of trusted fiduciary share holders from each category, in order for them to know which trusted parties 57 they would need to contact.

This second set of Authenticator 55 provides the authorization request to the trusted parties 57 of its category and further provides the User ID to an Encrypter unit 56. Once the authorizing users 57 agree to authorize the data access, their fiduciary share is transferred to the Encrypter unit 56 to be encrypted with the requesting user's public key. It will be appreciated that the Encrypter unit 56 may be a separate module for the category or may be implemented in each trusted party 57 computer unit.

Furthermore, the embodiment presented in FIG. 8 illustrates the requestor's unit 49 receiving the encrypted fiduciary shares from the required trusted parties 57, as well as receiving the fiduciary parameters passed down from the Authenticator 55. After receiving all the required fiduciary shares required to authorize the data access, the requestor's unit may then be able to perform the secret solving process 59. Once the Session Key is solved, the requestor's unit may then decrypt the Block ID's data payload 60, and thus the requesting user 58 may view the sensitive data on a content viewer 61.

It will be appreciated that the embodiment illustrated in FIG. 8 may be adapted to function with fiduciary sub-shares, for systems implementing a more complex data access control featuring different levels of authorization and constraints on categories access to the data.

In another embodiment, the Store of Sensitive Data 52 may be separated in two entities, one in which the encrypted data resides and another in which the fiduciary share parameters reside. This embodiment may allow quicker access to the sensitive data and the distribution of the information on the fiduciary parameters in an embodiment for which a Share Exchange Facilitator 54 would be the connecting service between the requesting user 58 and the trusted parties 57 holding the necessary fiduciary shares.

It will be appreciated by someone skilled in the art that the Store of Sensitive Data 52, as shown in the embodiment of FIG. 8, may be a physical server database storing the sensitive data or any other data storage solution, such as cloud-based data storing. The cloud-based data storing solution may further be implemented through internet, intranet or any other distribution means.

In some embodiments, the requestor unit may incorporate the solver and the data decrypter inside the CPU. Using some implementations of secure data processing already included by manufacturers in their processor (include AMD secure processing reference?) may ensure that no rogue computer programs may access the Session Key decryption secret.

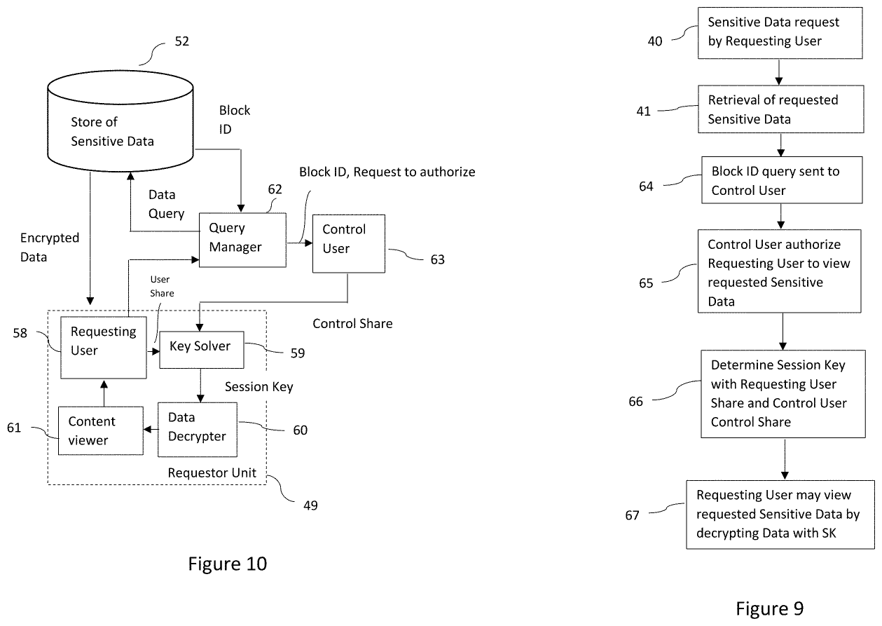

FIG. 9 illustrates an embodiment of a process in which a requesting user asks authorization to access the secured sensitive data 40. Once the request to access a given block of encrypted data is sent, the system retrieves the identification of the requested block 41, in order to be able to send the authorization request to the correct control user 64. Following the reception of the authorization request, the control user may decide to authorize 65 the requesting user to access the sensitive data, and thus provide this requesting user with his control share. The requesting user may then determine the Session Key that was used to encrypt the block's data by merging together both his user share and the received control share 66. It will be appreciated that this merging of shares may be implemented in any fashion, an example being that the shares are required to be XOR′ed. Once the Session Key has been determined, the requesting user may decrypt the sensitive data and view its content 67.

FIG. 10 is an illustration of a system implementing the secure data access protocol discussed in FIG. 9. In this embodiment, a requesting user 58 sends a request for access to sensitive data that is encrypted with a Session Key that he himself does not fully possess. A Query Manager module 62 receives the request and retrieves the requested data Block ID, which it then passes to a Control User 63. The Control User 63 may then authorize the data access by sending his Control Share to the requestor's unit Key Solver 59. The Key Solver 59, which also has the key share from its User, may combine those two shares to produce the Session Key. Once the Session Key is known, the requested sensitive data may be decrypted 60 and viewed by the requesting user 61.

In some embodiments, the control user may be a server. This implementation of the system allows the tracking of who requests access to what sensitive data and, more importantly, may be used to prevent someone who would have stolen a computer to have the ability to access the sensitive data in cases where a user's private key is implemented for calculations directly inside the CPU. The control server may then refuse all the authorization requests from a given compromised user.

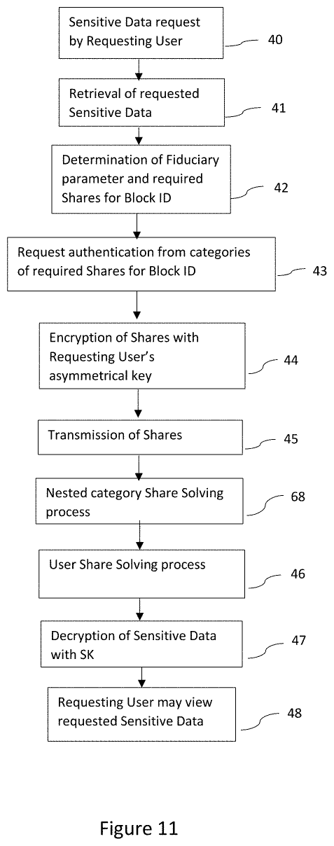

FIG. 11 is an illustration of an authorization process to access requested sensitive data that features a nested category share solving process. As detailed in the description of FIG. 4 and FIGS. 6 to 8, different categories of trusted parties may be implemented for a more complex security infrastructure. This process adds the nested category solving to the process shown in FIG. 6, such that the requesting user receives fiduciary sub-shares instead of the fiduciary shares. Thus, before gaining the ability to solve the fiduciary shares secret, the requestor needs to proceed with a fiduciary sub-share solving step 68 that results in the required fiduciary shares to be further used.

Nesting a share solving step for the different categories may result in increased security when deciding who, from the trusted parties, may access the sensitive data. It will be appreciated that different embodiments may allow different distribution of access and authorizing rights to different categories. In an embodiment, the users from one category may have enough fiduciary shares to solve between themselves the Session Key secret, whereas other trusted parties from other categories may yet require a fiduciary part from the first independent category in order to have enough information to solve the Session Key secret.

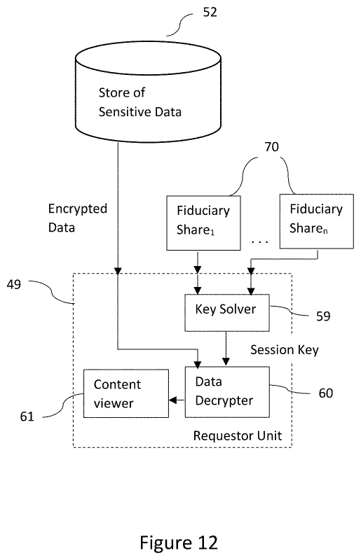

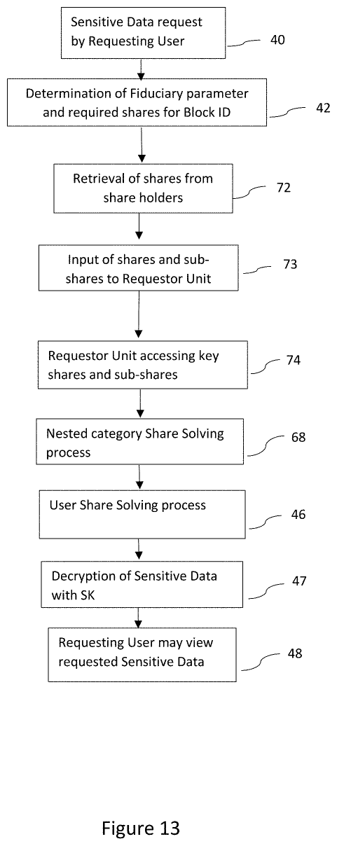

FIG. 12 is an illustration of a system implementing the process further described in FIG. 13, for which the fiduciary shares and sub-shares may be communicated through a physical medium. In some embodiments, the fiduciary shares and sub-shares 70 may be stored on encrypted usb keys, such that accessing the fiduciary share or sub-share 70 stored on the usb key may only be done when the encrypted usb key is connected to a computer and a password known to the user is entered. In other embodiments, the physical medium storing the fiduciary shares or sub-shares 70 may be any other electronical means, a paper with the share or sub-share written on it, or any other physical means of communicating the fiduciary share or sub-share 70 between users.

In the embodiment of FIG. 12, the requestor's unit 49, which may be a computer, may be connected to a store of sensitive data 52, such as an external hard drive or a usb key, and may further be connected to a number of physical mediums storing a fiduciary share or sub-share 70. The store of sensitive data 52 may also be accessed by the requestor unit 49 through a network, such that it may reside on an external server. In other embodiments, the fiduciary shares or sub-shares 70 may be manually entered by the requesting user on his requestor unit 49, such as by using a series of keys with a computer's keyboard.

The requestor unit 49 comprises a key solver 59, which may solve input fiduciary shares and sub-shares 70, which may include nested categories share solving, to ultimately result in the session key required to decrypt the requested sensitive data. Once the key solver 59 outputs the session key, a data decrypter 60 may use it to decrypt the requested sensitive data received from the store of sensitive data 52, such that the requesting user may view the sensitive data on a content viewer 61.

Now referring to FIG. 13 which presents a flow diagram setting out steps involved in viewing encrypted data according to an embodiment in which the requesting user obtain physical copies of the fiduciary sub-shares required to solve and obtain the fiduciary shares to further solve and obtain the session key used to decrypt the encrypted data payload.

A user desiring to gain access to sensitive data that has been encrypted with a session key as described herein must first request such access 40, which may be as simple as a user asking a supervisor's approval, filling necessary paperwork or filing a request on a network program. This request step 40 also provides the requesting user with the possibility of identifying the fiduciary parameters and the required fiduciary shares and sub-shares to decrypt the desired data 71.

The user may thereafter retrieve the fiduciary shares or sub-shares, from the key share holders, which may be included on physical mediums (e.g. usb key) 72. Once retrieved, the key shares and sub-shares may be input in the requestor unit 73, which may be done by connecting the usb key to the requestor unit, by manually entering the keys with the keyboard or in any other related physical manner.

Following this, the requestor unit may access the fiduciary shares or sub-shares 74 such that they may be used in the user share solving process 46. In some embodiments, a nested category share solving process 68 may also be included prior to the user share solving process 46. The decryption of the requested sensitive data 47 may then be done with the solved session key and therefore the requesting user may view the sensitive data 48 at his discretion.

What is claimed is:

1. A method to allow a user to view symmetrically encrypted data payloads whose Session Key is separated into two or more shares among shareholders, comprising:
a. receiving, from a server, a user share or sub-share asymmetrically encrypted using the user's public key which can be used in the decryption of a symmetrically encrypted data payload stored on the server;
b. decrypting the asymmetrically encrypted share or sub-share using the user's private key to obtain said user share or sub-share;
c. when decryption of the symmetrically encrypted data payload is required:
i. requesting other trusted parties that have shares or sub-shares needed to solve for the Session Key to decrypt their shares or sub-shares, asymmetrically encrypt them using the user's public key and transmit them to the user;
ii. decrypting the transmitted asymmetrically encrypted shares using the user's private key;
iii. solving for the Session Key using the decrypted shares and sub-shares;
iv. decrypting the encrypted data payload; and
v. viewing the decrypted data payload; and
d. when receiving a request to provide said user share or sub-share to another authenticated one of said shareholders:
i. encrypting said user share or sub-share using a public key of said other authenticated one of said shareholders; and
ii. transmitting said encrypted user share or sub-share in response to said request.

2. The method of claim 1, wherein receiving a share or sub-share from a server further comprises receiving additional information accompanying the share or sub-share, wherein the additional information comprises a symmetrically encrypted data payload which the user's share or sub-share used for decrypting, the fiduciary parameter of the symmetrically encrypted data payload, the fiduciary sub-share parameters of the symmetrically encrypted data payload and a list of shareholders from whom the user may request shares and sub-shares.

3. The method of claim 1, further comprising, prior to decrypting the encrypted data payload, requesting and receiving from a server storing the symmetrically encrypted data payload which the user's share or sub-share is used to decrypt, the symmetrically encrypted data payload which the user's share or sub-share is used to decrypt.

4. The method of claim 1, further comprising, prior to step (c)(i), determining the number of shares and sub-shares from each category required to decrypt the symmetrically encrypted data payload by requesting and receiving from the server the fiduciary parameter of the symmetrically encrypted data payload, the fiduciary sub-share parameters of the symmetrically encrypted data payload and a list of shareholders from whom the user may request shares and sub-shares to inform the user of where and to whom to transmit the request.

5. The method of claim 1, wherein step (c)(i) comprises manually transmitting requests to other shareholders.

6. The method of claim 1, wherein step (c)(i) comprises submitting a request to a share exchange facilitator which will automatically transmit the user's request to all relevant shareholders without the user needing to know of or be in contact with the shareholders.

7. The method of claim 1, wherein receiving a request to provide a user share or sub-share comprises receiving a request directly from another user.

8. The method of claim 1, wherein receiving a request to provide a user share or sub-share comprises receiving a request from a share exchange facilitator.

9. The method of claim 1, wherein encrypting said user share or sub-share involves transmitting the share or sub-share to an encrypter unit separate from the user's computer.

10. The method of claim 1, wherein encrypting said user share or sub-share involves encrypting the share or sub-share using an encrypter unit in the user's computer.

11. The method of claim 1, transmitting said encrypted user share or sub-share in response to said request comprises transmitting the encrypted share or sub-share to the requesting user directly.

12. The method of claim 1, transmitting said encrypted user share or sub-share in response to said request comprises transmitting the encrypted share or sub-share to an authenticator or a share exchange facilitator, which will in turn transmit the encrypted share or sub-share to the requesting user, so that the user remains anonymous.

13. The method of claim 1, wherein the shares and sub-shares represent points of a polynomial function the degree of which is equal to the fiduciary parameter, where the Session Key is the zero of the polynomial function to allow for more efficient decryption.

14. The method of claim 1, further comprising, if solving for the Session Key using the decrypted shares and sub-shares and decrypting the encrypted data payload are performed on a user's computer, using some implementations of secure data processing already included by the manufacturers in the processor of the user's computer to ensure that no rogue computer programs may access the Session Key or decrypted data payload.

15. The method of claim 1, wherein any transmission or request of information sent from the user is first transmitted to an authenticator before reaching its eventual destination, so that an authenticator system can track which users communicate with each other, which users share shares or sub-shares, and which users view which data payloads.

16. The method of claim 1, wherein any transmission or request of information sent from the user is accompanied by the user's User ID to allow for a system authenticator to track which users communicate with each other, which users share shares or sub-shares, and which users view which data payloads.

17. A computer-readable non-transitional memory storing instructions executable by a computer device of a user for viewing symmetrically encrypted data payloads whose Session Key is separated into two or more shares among shareholders, comprising:
at least one instruction for causing:
receiving, from a server, a user share or sub-share asymmetrically encrypted using the user's public key which can be used in the decryption of a symmetrically encrypted data payload stored on the server;
decrypting the asymmetrically encrypted share or sub-share using the user's private key to obtain said user share or sub-share;
when decryption of the symmetrically encrypted data payload is required:
requesting other trusted parties that have shares or sub-shares needed to solve for the Session Key to decrypt their shares or sub-shares, asymmetrically encrypt them using the user's public key and transmit them to the user;
decrypting the transmitted asymmetrically encrypted shares using the user's private key;
solving for the Session Key using the decrypted shares and sub-shares;
decrypting the encrypted data payload; and
viewing the decrypted data payload; and
when receiving a request to provide said user share or sub-share to another authenticated one of said shareholders:
encrypting said user share or sub-share using a public key of said other authenticated one of said shareholders; and
transmitting said encrypted user share or sub-share in response to said request.
